(19) United States
(12) Patent Application Publication
(10) Pub. No.: US 2010/0182951 A1
(43) Pub. Date: Jul. 22, 2010

(54) Apparatus and method for rate control in broadband wireless communication system

(75) Inventors: Myong-Hee Park, Suwon-si (KR); Sung-Kwon Jo, Suwon-si (KR); Jae-Hyok Lee, Yongin-si (KR); Ki-Hwan Hwang, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/657,387

(22) Filed: Jan. 20, 2010

(30) Foreign Application Priority Data
Jan. 21, 2009 (KR) 10-2009-0005143

(51) Int. Cl. H04W 40/00

(52) U.S. Cl. 370/328

(57) ABSTRACT

A method for rate control in a wireless communication system includes feedback information indicating whether a packet is received, is received from a receiver. A channel state value measured by the receiver is received. It is determined whether the same feedback information is received from the receiver successively more than a predetermined frequency. A target error rate is controlled if the same feedback information is received successively more than the predetermined frequency.

### CROSS-REFERENCE TO RELATED APPLICATION(S) AND CLAIM OF PRIORITY

The present application claims priority under 35 U.S.C. §119 to an application filed in the Korean Intellectual Property Office on Jan. 21, 2009 and assigned Serial No. 10-2009-0005143, the contents of which are incorporated herein by reference.

### TECHNICAL FIELD OF THE INVENTION

The present invention relates generally to a broadband wireless communication system, and in particular, to an apparatus and method for rate control in a broadband wireless communication system.

### BACKGROUND OF THE INVENTION

Nowadays, many wireless communication schemes are being proposed as candidates for high-rate mobile communication. Among them, an Orthogonal Frequency Division Multiplexing/Orthogonal Frequency Division Multiple Access (OFDM/OFDMA) scheme is being esteemed as the most prominent next-generation wireless communication scheme. It is expected that the OFDM/OFDMA scheme will be used in most wireless communication technologies.

A Hybrid Automatic Repeat reQuest (HARQ) scheme is used as a physical-layer packet retransmission algorithm to increase the downlink or uplink throughput in a wireless communication system. In the case of a downlink, a mobile station (MS) performs an error check on a packet, received from a base station (BS), and feeds an ACKnowledgement (ACK) or a Non-ACKnowledgement (NACK) back to the BS according to the check results. When receiving the ACK, the BS transmits the next packet (new packet) to the MS; and when receiving the NACK, the BS retransmits the previous packet to the MS. When receiving the retransmitted packet, the MS combines the retransmitted packet and the previously receive packet and performs a decoding operation. In this manner, the HARQ scheme increases the packet ACK probability, thereby improving the link throughput.

In a wireless communication system, a modulation order and code rate, to be applied to downlink data and uplink data, must be determined according to the channel environments. Hereinafter, the modulation order and code rate will be referred to as a Modulation and Coding Scheme (MCS) level.

At present, an OFDM/OFDMA broadband wireless communication system has a link table optimized considering the peripheral environment and the mobile speed of each MS, and a BS uses the link table to determine a data transmission scheme according to a Carrier-to-Interference and Nose Ratio (CINR) (e.g., a Channel Quality Indicator (CQI)) received from each MS. The link table defines a data transmission scheme for each CINR, which defines a CINR value satisfying a Packet Error Rate (PER) of 1% for each MCS level.

That is, the link table defines a CINR threshold value for each of the MCS levels supported by the system. In general, the CINR threshold value is experimentally determined assuming a plurality of channel environments. However, the link table fails to fully reflect all the environments of an actual system. Thus, if there is a difference between the link table and an actual environment, even when an MCS level is determined using a CINR measured by an MS, a reception error may occur, thus reducing the transmission efficiency (throughput). In order to overcome the above limitation, the BS controls the CINR by using HARQ feedback message (ACK or NACK) received from an MS and determines an MCS level by using the controlled CINR value. For example, the BS increases an offset value when receiving an ACK from an MS; decreases an offset value when receiving a NACK from the MS; and controls the CINR, reported from the MS, according to the offset value. The BS may compare the controlled CINR value with the link table to determine an MCS level to be applied to data.

However, the above conventional art increases/decreases an offset value in the event of an ACK/NACK but fails to reflect a special condition of the MS (e.g., the condition of failing to receive a specific MCS level), thus reducing the transmission efficiency (throughput). For example, assume an environment where there is no significant change in the CINR measured by the MS and the average CINR is maintained to be constant. In this case, the following conditions may repeat periodically.

(1) Occurrence of successive ACKs→(2) Increase in offset value→(3) Allocation of high MCS level (i.e., Allocation of MCS level incapable of being received by MS)→(4) Occurrence of successive NACKs→(5) Allocation of low MCS level

That is, the conditions (1) to (5) repeat and MCS levels, incapable of being received by the MS, are periodically allocated, thus reducing the transmission efficiency (throughput). In the event of the occurrence of successive NACKs, it is preferable that MCS levels are allocated conservatively. However, the conventional art fixes a feedback signal-dependent offset variation at a constant value, thus failing to accurately reflect the current state of the MS.

### SUMMARY OF THE INVENTION

To address the above-discussed deficiencies of the prior art, it is a primary object of the present invention is to substantially solve at least the above problems and/or disadvantages and to provide at least the advantages below. Accordingly, an object of the present invention is to provide an apparatus and method for controlling a channel state value in a wireless communication system in consideration of the state of an MS and determining an MCS level on the basis of the controlled channel state value.

Another object of the present invention is to provide an apparatus and method for controlling a channel state value, used to determine an MCS level, in a wireless communication system by using the successive occurrence times of the same feedback signal.

Another object of the present invention is to provide an apparatus and method for conservatively allocating an MCS level if a NACK occurs successively in a wireless communication system.

Another object of the present invention is to provide an apparatus and method for aggressively allocating an MCS level if an ACK occurs successively in a wireless communication system.

Another object of the present invention is to provide an apparatus and method for controlling an offset variation, used to control a channel state value, in a predetermined time if the same feedback signal occurs successively in a wireless communication system.

Another object of the present invention is to provide an apparatus and method for controlling a target error rate (e.g., FER and PER) if the same feedback signal occurs successively in a wireless communication system.

Another object of the present invention is to provide an apparatus and method for increasing the transmission efficiency (throughput) in a wireless communication system by controlling a channel state value, used to determine an MCS level, to an actual environment.

According to an aspect of the present invention, an apparatus for rate control in a wireless communication system includes: a feedback receiver that receives, from a receiver, feedback information indicating whether a packet is received; a channel information receiver that receives a channel state value measured by the receiver; and a control unit that uses the feedback information from the feedback receiver to determine whether the same feedback information is received successively more than a predetermined frequency and controls a target error rate if the same feedback information is received successively more than the predetermined frequency.

According to another aspect of the present invention, a method for rate control in a wireless communication system includes: receiving, from a receiver, feedback information indicating whether a packet is received; receiving a channel state value measured by the receiver; determining whether the same feedback information is received from the receiver successively more than a predetermined frequency; and controlling a target error rate if the same feedback information is received successively more than the predetermined frequency.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a signal exchange process in a wireless communication system according to an embodiment of the present invention;

FIG. 2 illustrates an operational process of a BS in a wireless communication system according to an embodiment of the present invention;

FIG. 3 illustrates a BS in a wireless communication system according to an embodiment of the present invention;

FIG. 4 illustrates an offset change in an OLRC operation according to an embodiment of the present invention; and

FIG. 5 illustrates a graph of the performance of the present invention.

### DETAILED DESCRIPTION OF THE PREFERRED EMBODIMENTS

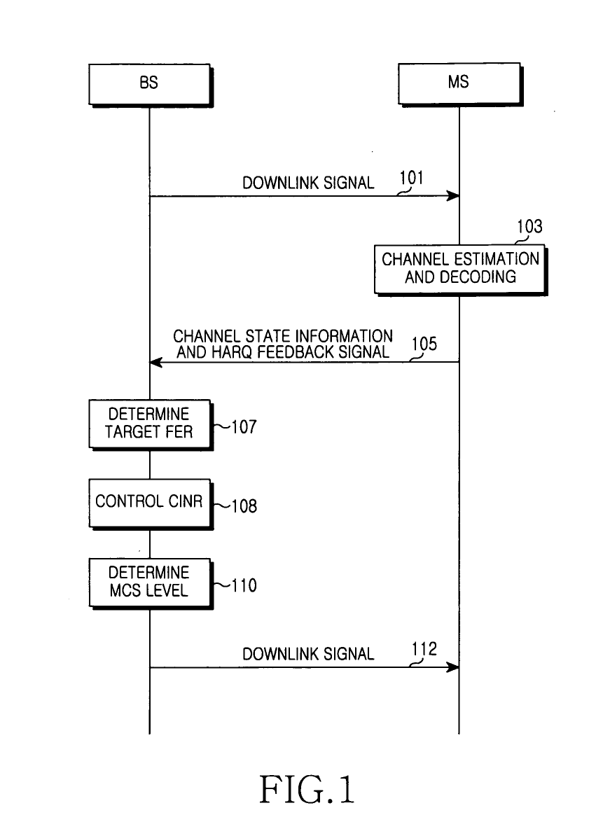

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Preferred embodiments of the present invention will be described herein below with reference to the accompanying drawings. In the following description, detailed descriptions of well-known functions or constructions will be omitted since they would obscure the invention in unnecessary detail. Also, the terms used herein are defined according to the functions of the present invention. Thus, the terms may vary depending on user's or operator's intentions or practices. Therefore, the terms used herein should be understood based on the descriptions made herein.

The present invention provides a scheme for controlling a channel state value, used to determine an MCS level through an Outer-Loop Rate Control (OLRC), in consideration of both a feedback signal and the successive occurrence frequency of the same feedback signal.

The following description is made in the context of an OFDM/OFDMA broadband wireless access system, to which the present invention is not limited. Thus, it should be clearly understood that the present invention is also applicable to any other wireless communication system that uses a channel state value to determine a transmission rate (e.g., an MCS level).

An example of the OLRC is expressed as Equations (1) and (2). When a mobile station (MS) reports a measured channel state value (CINR) and a feedback signal (ACK or NACK) for received data to a base station (BS), the BS controls the channel state value according to the feedback signal. If the feedback signal is an ACK, an offset value is controlled as Equation 1; and if the feedback signal is a NACK, an offset value is controlled as Equation 2. Herein, the feedback signal and the channel state value may be reported at the same time or at different times.

VCINR=CINR+Offset,

Offset=Offset+UP, UP=DOWN×(Target FER)/(1−Target FER) [Eqn. 1]

VCINR=CINR+Offset, Offset=Offset−DOWN [Eqn. 2]

In Equations 1 and 2, a CINR value denotes a channel state value reported as an OLRC input value from the MS, and a VCINR (Virtual CINR) value denotes an OLRC output value. The BS compares the OLRC output value and a link table to determine an MCS level. A target Frame Error Rate (FER) is an example of a target error rate, and a target Packet Error Rate (PER) may be used instead of the target FER. A DOWN value is a constant value, and an UP value is determined according to the target FER. Thus, if the target FER increases, the UP value increases so that the MCS level can be allocated aggressively. Alternatively, if the target FER decreases, the UP value decreases so that the MCS level can be allocated conservatively.

The present invention changes the target FER in a predetermined timer period if the same feedback signal occurs successively more than a predetermined frequency. For example, if the NACK occurs successively more than a predetermined frequency, the BS may control the target FER (or PER) to be smaller than an initial value (a default value). Alternatively, if the ACK occurs successively more than the predetermined frequency, the BS may control the target FER to be greater than the initial value. That is, if the NACK occurs successively, the present invention may decrease the target FER to conservatively allocate the MCS level; and if the ACK occurs successively, the present invention may increase the target FER to aggressively allocate the MCS level.

Although the following description focuses on downlink communication for convenience in description, it should be clearly understood that the present invention is also applicable to uplink communication.

FIG. 1 illustrates a signal exchange process in a wireless communication system according to an embodiment of the present invention.

Referring to FIG. 1, a BS transmits a downlink signal (or a downlink frame) to an MS in step 101. The downlink signal may include a reference signal (e.g., a preamble signal and a pilot signal) for MS channel estimation, a resource allocation message (e.g., a MAP message), and a plurality of downlink packets (or downlink bursts). Herein, the downlink packet may be a signaling message or traffic data.

In step 103, the MS receives the downlink signal from the BS, performs channel estimation by using the reference signal in the downlink signal, and decodes its own packet in the downlink signal. In step 105, the MS transmits channel state information (e.g., CQI and CINR), obtained through the channel estimation, and the decoding result (e.g., an HARQ feedback signal such as ACK and NACK) to the BS. Although it is assumed herein that the channel state information and the HARQ feedback signal are fed back to the BS at the same time, the channel state information and the HARQ feedback signal may be fed back to the BS at different times. Also, the MS may feed a MAC ARQ feedback message (i.e., a MAC layer decoding result) back to the BS.

According to the HARQ feedback signal received from the MS, the BS may retransmit the previously transmitted packet or may transmit new packets. If receiving the ACK from the MS, the BS performs scheduling of new packets.

That is, in step 107, the BS determines whether control of the target FER for the MS is necessary. Herein, the BS determines whether the same feedback signal is received from the MS successively more than a predetermined frequency. If the same feedback signal is received from the MS successively more than the predetermined frequency, the BS controls the target FER and applies the controlled target FER value in a predetermined timer period to determine an MCS level. For example, if the NACK is received successively more than a predetermined frequency, the BS controls the target FER to be smaller than an initial value; and if the ACK is received successively more than a predetermined frequency, the BS controls the target FER to be greater than the initial value. If the above condition is not satisfied, the BS maintains the target FER to be the initial value.

In step 108, the BS controls the channel state information (CINR), received from the MS, according to the feedback signal received from the MS. If the feedback signal is the ACK, the BS controls the channel state information as Equation 1; and if the feedback signal is the NACK, the BS controls the channel state information as Equation 2. Herein, the target FER of Equation 1 may be the target FER value determined in step 107. It is assumed that the BS performs an operation of Equations 1 or 2 by using the last received CINR and the last received feedback signal (i.e., the feedback signal regarding the initial transmission packet).

In step 110, the BS compares the controlled channel state information with a link table to determine an MCS level to be applied to a downlink packet.

In step 112, the BS modulates a downlink packet, to be transmitted to the MS, by the determined MCS level and transmits a downlink frame including the modulated packet to the MS.

Although it has been described with reference to FIG. 1 that the CINR is controlled using the HARQ feedback signal, the CINR may also be controlled using a MAC layer ARQ feedback signal. The following description is made on the assumption of using the HARQ feedback signal.

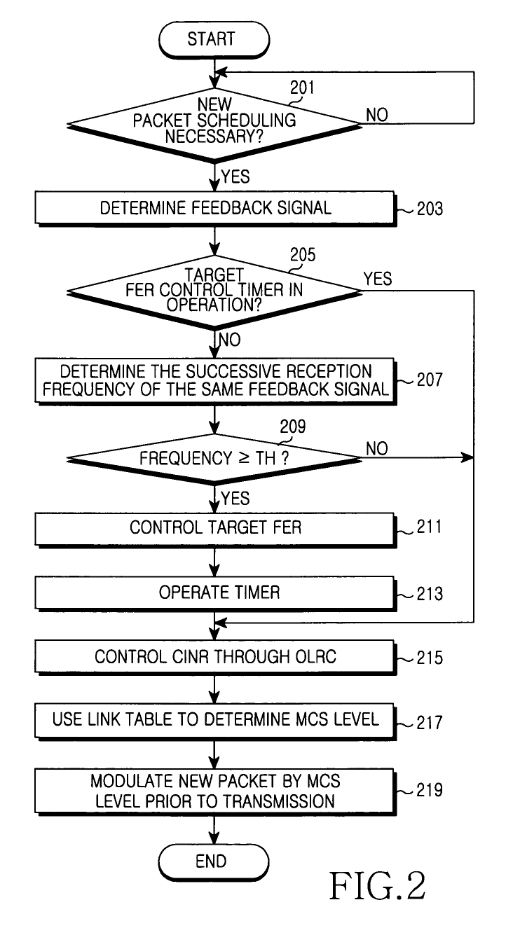

FIG. 2 illustrates an operational process of a BS in a wireless communication system according to an embodiment of the present invention.

Referring to FIG. 2, in step 201, the BS determines whether scheduling of a new packet is necessary. Herein, the new packet is an initial transmission packet transmitted through the corresponding HARQ connection. For example, if receiving the ACK regarding the previously transmitted packet, the BS may initially transmit the next new packet.

If the new packet scheduling is necessary, the BS proceeds to step 203. In step 203, the BS determines the last received feedback signal (ACK or NACK). Herein, it is assumed that the last received feedback signal is a feedback signal regarding the last-transmitted initial transmission packet. That is, it is assumed that a feedback signal regarding a retransmission packet is not considered in an embodiment of the present invention.

In step 205, the BS determines whether a target FER control timer is in operation for the corresponding HARQ connection. That is, the BS determines whether the target FER is already controlled. If the target FER control timer is in operation, the BS proceeds directly to step 215.

If the target FER control timer is not in operation, the BS proceeds to step 207. In step 207, the BS determines the successive reception frequency of the same feedback signal. In step 209, the BS determines whether the successive reception frequency is equal to or greater than a threshold value (TH). Although it is described herein that the threshold value is the same regardless of the feedback types, the threshold value may vary depending on the feedback types. For example, if the same feedback signal is the NACK, the threshold value may be set to a first value (e.g., 4); and if the same feedback signal is the ACK, the threshold value may be set to a second value (e.g., 3).

If the successive reception frequency is smaller than the threshold value, the BS proceeds directly to step 215. Alternatively, if the successive reception frequency is equal to or greater than the threshold value, the BS proceeds to step 211. In step 211, the BS controls the target FER (or PER) used in an OLRC operation. For example, if the NACK is received successively more than a threshold frequency, the BS controls the target FER to be smaller than an initial value; and if the ACK is received successively more than the threshold frequency, the BS controls the target FER to be greater than the initial value.

In step 213, the BS operates the target FER control timer. Herein, the target FER control timer is to set a control period (e.g., a ‘100’ frame) of the target FER. If the target FER control timer is in operation, the BS may use the controlled target FER to perform an OLRC operation.

In step 215, the BS uses an OLRC algorithm to control a CINR fed back from an MS. For example, if the feedback signal is determined to be the ACK (in step 203), the BS controls the CINR as Equation 1; and if the feedback signal is determined to be the NACK (in step 203), the BS controls the CINR as Equation 2. Herein, the target FER of Equation 1 may be a default value (e.g., 0.1) or a controlled value (e.g., 0.01).

In step 217, the BS compares the controlled CINR with a link table to determine an MCS level. In step 219, the BS modulates the new packet by the determined MCS level prior to transmission to the MS.

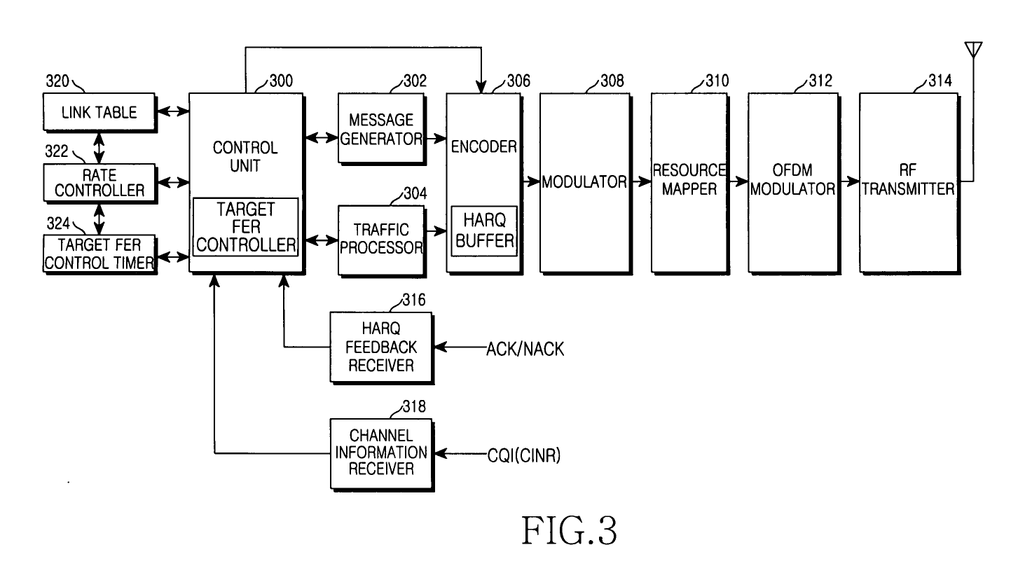

FIG. 3 illustrates a BS in a wireless communication system according to an embodiment of the present invention.

Referring to FIG. 3, the BS includes a control unit 300, a message generator 302, a traffic processor 304, an encoder 306, a modulator 308, a resource mapper 310, an OFDM modulator 312, a Radio Frequency (RF) transmitter 314, an HARQ feedback receiver 316, a channel information receiver 318, a link table 320, a rate controller 322, and a target FER control timer 324. For simplicity's sake, the illustration focuses on the configuration of a transmitter. The HARQ feedback receiver 316 and the channel information receiver 318 may be a physical channel receiver configured to demodulate a fast feedback channel (e.g., ACKCH and CQICH), or may be a receiver configured to demodulate/interpret a received MAC management message.

The HARQ feedback receiver 316 interprets HARQ feedback information (e.g., ACK and NACK), received from an MS, and provides the same to the control unit 300. The channel information receiver 318 interprets channel state information (e.g., CINR), received from the MS, and provides the same to the control unit 300.

The control unit 300 performs resource scheduling and controls the corresponding component according to the scheduling result. According to the present invention, the control unit 300 controls an overall operation for OLRC. If scheduling of a new packet (an initial transmission packet) is necessary for HARQ connection, the control unit 300 includes a target FER controller to determine the last received HARQ feedback information (ACK or NACK) with regard to the HARQ connection and to determine whether the same feedback information is received successively more than a predetermined frequency. If the same feedback information is received successively more than the predetermined frequency, the control unit 300 controls a target FER (or PER) used in an OLRC operation. For example, if the NACK is received successively more than the predetermined frequency, the control unit 300 controls the target FER to be smaller than the current initial value; and if the ACK is received successively more than the predetermined frequency, the control unit 300 controls the target FER to be greater than the current initial value. When the target FER is controlled, the control unit 300 operates the target FER control timer 324. While the target FER control timer 324 is operating, the rate controller 322 uses the controlled target FER to perform an OLRC operation.

By using the controlled target FER, the HARQ feedback information received from the MS, and the channel state information (CINR) received from the MS, the rate controller 322 performs an OLRC algorithm to control the CINR. Herein, the rate controller 322 may use Equations 1 and 2 to perform the OLRC algorithm. For example, if the last received feedback signal is the ACK, the rate controller 322 controls the CINR as Equation 1, and if the last received feedback signal is the NACK, the rate controller 322 controls the CINR as Equation 2. Thereafter, the rate controller 322 compares the controlled CINR and the link table 320 to determine an MCS level to be applied to a new packet. Herein, the link table 300 may be a memory table that defines a CINR threshold value for each of the MCS levels supported by the system.

The message generator 302 generates a signaling message (e.g., a MAC management message) by using various control information received from the control unit 300. For example, the message generator 302 may generate a MAP message by using the scheduling information received from the control unit 300.

The traffic processor 304 converts transmit (TX) data into a data burst (a physical layer packet) according to the protocol and transfers the same to the encoder 306 of a physical layer.

The encoder 306 encodes the signaling message from the message generator 302 and the data packet from the traffic processor 304 by the MCS level determined by the controller 300. Herein, for example, the encoder 306 may use a convolutional code (CC), a turbo code (TC), a convolutional turbo code (CTC), or a low density parity check (LDPC) code. In an HARQ operation, the encoder 306 buffers encoded data (or bits) regarding the data packet in an HARQ buffer and may retransmit all or some of the buffered encoded data according to an HARQ scheme (e.g., chase combining and IR) if receiving a retransmission request (NACK) from a receive (RX) terminal.

The modulator 308 modulates the encoded data from the encoder 306 by the MCS level to generate modulated symbols. For example, the modulator 308 may use a QPSK, 16 QAM or 64 QAM scheme.

The resource mapper 310 maps the data from the modulator 308 to a predetermined resource (or subcarrier). The OFDM modulator 312 OFDM-modulates the resource-mapped data from the resource mapper 310 to generate an OFDM symbol. Herein, the OFDM modulation includes Inverse Fast Fourier Transform (IFFT) and Cyclic Prefix (CP) addition. The RF transmitter 314 converts the sample data from the OFDM modulator 312 into an analog signal, converts the analog signal into an RF signal, and transmits the RF signal through an antenna.

As described above, the present invention prevents the condition of a reception error occurrence to increase the transmission efficiency (throughput). For example, a description will be given of the case where the NACK occurs successively. It is assumed that the initial value of the target FER is ‘0.1’ and the target FER is controlled to a predetermined value (e.g., ‘0.01’) when the NACK occurs successively four or more times. Also, it is assumed that a DOWN value used in an OLRC operation is ‘0.5’.

If the target FER is set to the initial value and the ACK occurs, an UP value is equal to [DOWN×(Target FER)/(1−Target FER)=0.5×0.1/0.9=0.05]. That is, if the ACK occurs, the CINR increases by ‘0.05’. Alternatively, if the NACK occurs more than four or more times and the target FER is controlled to ‘0.01’, the UP value is equal to [DOWN×(Target FER)/(1−Target FER)=0.5×0.01/0.09=0.005]. That is, if the ACK occurs, the CINR increases by ‘0.005’, so that the MCS level may be determined more conservatively than the case of the target FER being the initial value.

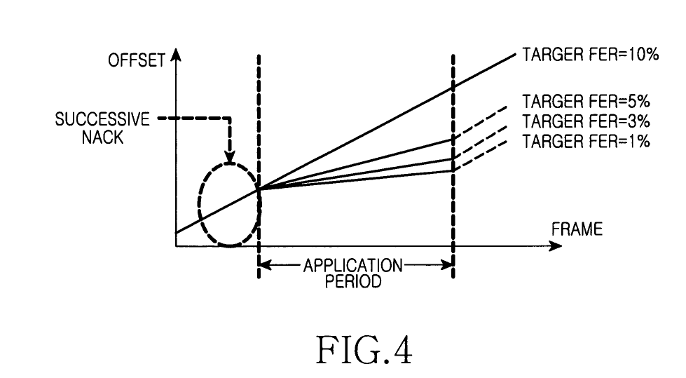

FIG. 4 illustrates an offset change in an OLRC operation according to an embodiment of the present invention.

FIG. 4 illustrates an offset change in the case of the target FER being 10%, 5%, 3% or 1%. It can be seen from FIG. 4 that the offset change slope increases as the target FER increases. For example, if the NACK occurs successively, the present invention decreases the target FER to control the offset change gradually. In this case, the MCS level can be conservatively allocated, thus preventing the condition of a reception error occurrence. The target FER is controlled only in a predetermined period (an application period) and may be restored to the initial value (the default value) at the expiration of a predetermined period.

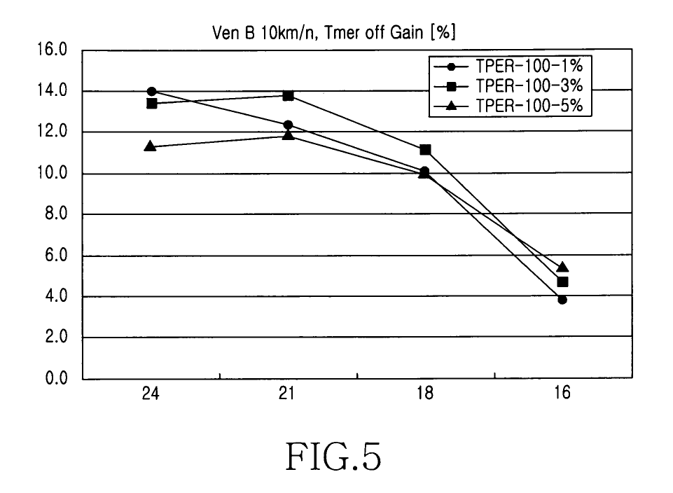

FIG. 5 illustrates a graph of the performance of the present invention.

In FIG. 5, the horizontal axis represents the CINR and the vertical axis represents the gain ratio of the present invention to the conventional art. That is, the gain increases as the value of the vertical axis increases. In the example, the target FER of the conventional art was fixed at 10%, and the target FER of the present invention was fixed at 1%, 3% or 5% for a 100-frame period in the event of successive NACK occurrence. The use of the present invention increases the gain greatly at a high CINR and provides a gain increase of 10% or more, as illustrated in FIG. 5.

As described above, the BS controls a target error rate in a predetermined period (an application period) if the same feedback signal is received from the MS successively more than the predetermined frequency, thereby controlling offset change slope according to an embodiment of the present invention. However, the BS sets upper limit value of an offset value in a predetermined period (an application period) if the same feedback signal is received from the MS successively more than the predetermined frequency according to another embodiment of the present invention. The upper limit value of an offset value is set an offset value at the time when the same feedback signal is received from the MS successively more than the predetermined frequency. Thereby, a specific MCS level can be not allocated aggressively.

As described above, the present invention controls the channel state value, used to determine the MCS level (or the transmission rate) in the wireless communication system, in consideration of both the feedback signal and the successive occurrence frequency of the same feedback signal, thereby making it possible to control the channel state value to be suitable for the actual environment. That is, the present invention adjusts the channel state value (CINR) to the actual environment to allocate the MCS level, thereby making it possible to increase the transmission efficiency (throughput).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for rate control in a wireless communication system, the apparatus comprising:
a feedback receiver configured to receive feedback information indicating whether a packet is received;
a channel information receiver configured to receive a channel state value measured by the receiver; and
a control unit configured to use the feedback information from the feedback receiver to determine whether the same feedback information is received successively more than a predetermined frequency and control a target error rate if the same feedback information is received successively more than the predetermined frequency.

2. The apparatus of claim 1, further comprising a rate controller configured to use the target error rate from the control unit and the feedback information from the feedback receiver to control the channel state value.

3. The apparatus of claim 2, further comprising a memory configured to store a link table that defines a threshold value of the channel state value corresponding to each Modulation and Coding Scheme (MCS) level.

4. The apparatus of claim 3, wherein the rate controller is configured to compare the controlled channel state value and the link table to determine an MCS level.

5. The apparatus of claim 4, further comprising a transmitter configured to modulate a transmit (TX) packet by the determined MCS level prior to transmission.

6. The apparatus of claim 2, further comprising a timer configured to set an application period of the controlled target error rate,
wherein the rate controller is configured to apply the controlled target error rate in an Outer-Loop Rate Control (OLRC) operation while the timer is in operation, and restores the target error rate to a default value at the expiration of the timer.

7. The apparatus of claim 1, wherein the control unit is configured to set an upper limit value of an offset value, which sets an offset value at the time when the same feedback information is received successively more than the predetermined frequency, instead of controlling the target error rate.

8. The apparatus of claim 1, wherein if a Non-ACKnowledgement (NACK) is received successively more than a predetermined frequency, the control unit is configured to control the target error rate to be smaller than a default value.

9. The apparatus of claim 1, wherein if an ACKnowledgement (ACK) is received successively more than a predetermined frequency, the control unit is configured to controls the target error rate to be greater than a default value.

10. The apparatus of claim 1, wherein the target error rate is one of a target Packet Error Rate (PER) and a target Frame Error Rate (FER), and the channel state value is a Carrier-to-Interference and Noise Ratio.

11. A method for rate control in a wireless communication system, the method comprising:
receiving, from a receiver, feedback information indicating whether a packet is received;
receiving a channel state value measured by the receiver;
determining whether the same feedback information is received from the receiver successively more than a predetermined frequency; and
controlling a target error rate if the same feedback information is received successively more than the predetermined frequency.

12. The method of claim 11, further comprising controlling the last received channel state value by using the target error rate and the last received feedback information.

13. The method of claim 12, further comprising setting a link table that defines a threshold value of the channel state value corresponding to each Modulation and Coding Scheme (MCS) level.

14. The method of claim 13, further comprising comparing the controlled channel state value and the link table to determine an MCS level.

15. The method of claim 14, further comprising modulating a transmit (TX) packet by the determined MCS level prior to transmission.

16. The method of claim 11, further comprising operating a timer to set an application period of the controlled target error rate.

17. The method of claim 16, further comprising restoring the target error rate to a default value at the expiration of the timer.

18. The method of claim 11, further comprising setting upper limit value of an offset value, which sets an offset value at the time when the same feedback information is received successively more than the predetermined frequency, instead of controlling a target error rate if the same feedback information is received successively more than the predetermined frequency.

19. The method of claim 11, wherein controlling the target error rate comprises:
controlling the target error rate to be smaller than a default value, if a Non-ACKnowledgement (NACK) is received successively more than a predetermined frequency; and
controlling the target error rate to be greater than the default value, if an ACKnowledgement (ACK) is received successively more than a predetermined frequency.

20. The method of claim 11, wherein the target error rate is one of a target Packet Error Rate (PER) and a target Frame Error Rate (FER), and the channel state value is a Carrier-to-Interference and Noise Ratio.
